(19) United States
(12) Patent Application Publication
(10) Pub. No.: US 2007/0266997 A1
(43) Pub. Date: Nov. 22, 2007

(54) EVAPORATIVE EMISSION CONTROL USING SELECTIVE HEATING IN AN ADSORBENT CANISTER

(76) Inventors: Clarence Reid Clontz JR., Fincastle, VA (US); Laurence H. Hiltzik, Charleston, SC (US); Edward Donald Tolles, Charleston, SC (US); Roger Shaw Williams, Daniel Island, SC (US)

Correspondence Address: MEADWESTVACO CORPORATION, 1021 MAIN CAMPUS DRIVE, 3RD FLOOR, CENTENNIAL CAMPUS, RALEIGH, NC, 27606, US

(21) Appl. No.: 11/678,331

(22) Filed: Feb. 23, 2007

Related U.S. Application Data
(63) Continuation-in-part of application No. 11/469,740, filed on Sep. 1, 2006, now abandoned.
(60) Provisional application No. 60/720,097, filed on Sep. 23, 2005.

(51) Int. Cl. F02M 33/06

(52) U.S. Cl. 123/519

(57) ABSTRACT

An invention is disclosed for efficiently improving the working capacity and useful service life of an evaporative emission control canister by selectively heating the adsorbent towards the purge outlet of the vapor path.

This application is a continuation-in-part application of co-pending and commonly assigned U.S. application Ser. No. 11/469,740, filed on Sep. 1, 2006, which claims priority from U.S. Provisional application Ser. No. 60/720,097, filed on Sep. 23, 2005, which are incorporated herein by reference.

### BACKGROUND OF THE INVENTION

1. Field of the Invention

This invention relates to a method for storage and recovery of evaporated emissions with a canister containing adsorbent with selective heating to assist vapor recovery and extend service life, and for using said canister with hydrocarbon fuel consuming engines.

2. Description of Related Art (Including Information Disclosed Under 37 CFR 1.97 and 37 CFR 1.98)

Evaporation of gasoline from motor vehicle fuel systems is a major potential source of hydrocarbon air pollution. The automotive industry is challenged to design engine components and systems to contain, as much as possible, the almost one billion gallons of gasoline evaporated from fuel systems each year in the United States alone. Such emissions can be controlled by canister systems that employ activated carbon to adsorb and hold the vapor that evaporates. Under certain modes of engine operation, the adsorbed hydrocarbon vapor is periodically removed from the carbon by drawing air through the canister and burning the desorbed vapor in the engine. The regenerated carbon is then ready to adsorb additional vapor. Under mandate from the EPA and the California Air Resources Board (CARB), such control systems have been employed in the U.S. for about 30 years, and during that time government regulations have gradually reduced the allowable emission levels for these systems. In response, improvements in the control systems have been largely focused on improving the capacity of the activated carbon to hold hydrocarbon vapor. For example, current canister systems, containing activated carbon of uniform capacity, are readily capable of capturing and releasing 100 grams of vapor during adsorption and air purge regeneration cycling. These canister systems also must have low flow restrictions in order to accommodate the bulk flow of displaced air and hydrocarbon vapor from the fuel tank during refueling. Improvements in activated carbons for automotive emission control systems are disclosed in U.S. Pat. Nos. 4,677,086; 5,204,310; 5,206,207; 5,250,491; 5,276,000; 5,304,527; 5,324,703; 5,416,056; 5,538,932; 5,691,270; 5,736,481; 5,736,485; 5,863,858; 5,914,294; 6,136,075; 6,171,373; 6,284,705.

A typical canister employed in a state of the art auto emission control system is shown in FIG. 1. Canister 1 includes support screen 2, dividing wall 3, a vent port 4 to the atmosphere (the location of the purge inlet for the canister), a vapor source connection 5 (from the fuel tank), a vacuum purge connection 6 (the location of the purge outlet for when the engine is running), and adsorbent material fill 7 in the purge inlet volume 8 and in the purge outlet volume 9. A connecting plenum section is typically present between adsorbent volumes, such as plenum 10 in FIG. 1. Other basic auto emission control system canisters are disclosed in U.S. Pat. Nos. 5,456,236; 5,456,237; 5,460,136; and 5,477,836. It is common to design the purge inlet volume 8 such that its cross-sectional area is substantially less than that of volume 9, such as shown in FIG. 1, in order to enhance the local removal of adsorbed vapors during purge at the purge inlet by increasing the local purge flow per perpendicular cross sectional area of flow path during purge steps, and thereby reducing bleed emissions from the canister system during subsequent vehicle operation and diurnal breathing loss conditions. The adsorbent fills in volumes 8 and 9 might further comprise of materials with different adsorptive properties located in-series with the vapor flow path, as disclosed in U.S. Pat. No. 6,540,815, for reduced bleed emissions during diurnal breathing of the fuel system. Multiple chambers, beyond the two shown in FIG. 1, might be designed in the canister, and auxiliary canisters might be employed in the evaporative emissions control systems for capturing, recovering, and retaining fuel vapors.

Improvements in the performance of the canisters have been disclosed whereby the amount of recoverable vapor is increased and the emissions from the evaporative emission control system are reduced by the inclusion of a mode of heating to assist in the desorption, and therefore purge, of captured vapors during the regenerative step of the system operation, as taught in U.S. Pat. Nos. 5,981,930, 6,689,196, 6,701,902, and 6,823,851 for heating along the entire adsorbent flow path length, and in U.S. Pat. Nos. 4,280,466, 4,598,686, 4,721,846, 4,778,495, 4,864,103, 6,230,693, 6,279,548, and 6,773,491 for selectively heating the inlet purge flow or heating the volume of adsorbent first receiving the purge flow free of fuel vapor. Improvements in canister performance in terms of reduced vapor emissions, such as during diurnal breathing of the fuel system, are typically described for the heating of the incoming purge air or the purge inlet volume of adsorbent. Modes of heating include resistive wires, positive temperature coefficient (PTC) materials, and adsorbents, binders, and substrates with appropriate electrical resistivity properties for self-heating when current is applied.

Recent designs of vehicle engines for greater fuel efficiency, including combination hybrid electric/combustion engine drive trains and engines where multiple cylinders idle during operation, are challenged to provide for sufficient recovery of vapor emissions and for adequately low emissions because these engine systems do not provide a sufficient volume of purge for adsorbent regeneration. Only a fraction of the normal amount of purge volume is available for recovery of vapors, yet the emission control system is still required to capture and recover the same amount of fuel vapors compared with a conventional engine design. And, yet, there is an ever increased value for the design and operation of the evaporative emission control system to be such that “these components may be of small sizes with reduced power consumption,” as described by the patentees in U.S. Pat. No. 6,695,895. Furthermore, the useful life of an evaporative emission control canister for maintaining its recovery capacity for fuel vapors is threatened by the accumulation of higher boiling point components of the fuel vapor (C₇ and larger) along the vapor flow path from the fuel vapor source, as described in SAE Technical Paper 2000-01-0895, titled “Studies on Carbon Canisters to Satisfy LEV II EVAP Regulations,” by H. Itakura, N. Kato, T, Kohama, Y, Hyoudou, and T. Murai. The prescribed remedy from the authors is that the “deterioration of the current carbon canister can be restrained by increasing purge amount and thus Useful Life can be extended” (sic). Therefore, the reduction in purge volume with newer engine designs is counter to maintaining evaporative emission control system performance over years of vehicle usage as mandated by environmental regulations.

Through extensive study of adsorbent vapor distributions and thermal properties during canister operation, it became evident that prior methods of heating the purge inlet were inadequate for the extraordinary cycling conditions encountered in newer, purge-deficient engine designs in terms of enhancing adsorbent working capacity and for enhancing the service life of the evaporative emission control system for vapor recovery. The prior methods of heating along the entire flow path length require undesirably large components and require unnecessarily high power usage in heating the entire adsorbent, which is especially wasteful in light of the discovery that only a portion of the flow path need be heated.

### SUMMARY OF THE INVENTION

An invention is disclosed for efficiently improving the working capacity and useful service life of an evaporative emission control canister by selectively heating the adsorbent towards the purge outlet of the vapor path.

### BRIEF DESCRIPTION OF THE DRAWINGS

FIG. 1 is a sectional view of a conventional evaporative emission control system.

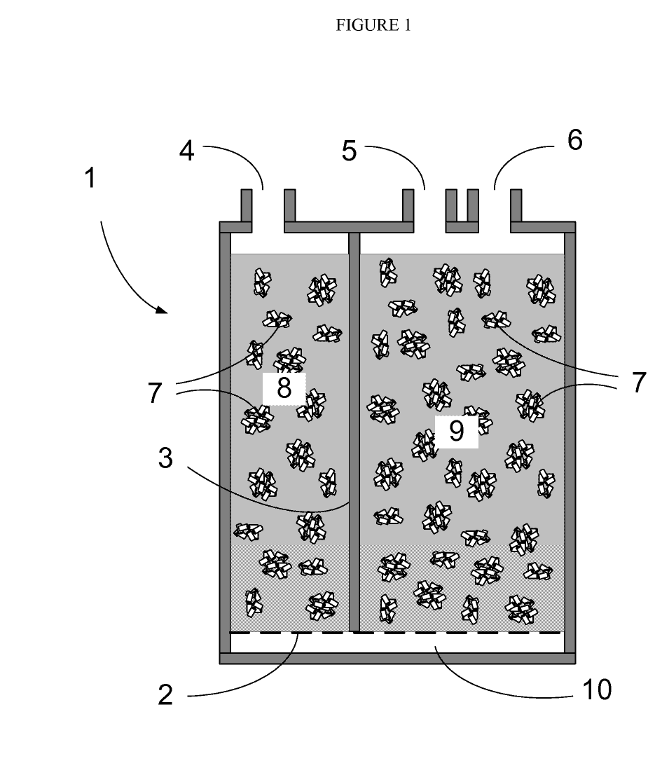

FIG. 2 is a sectional view of an evaporative emission control system with provisions for selectively heating the adsorbent towards the purge outlet according to the present invention.

FIG. 3 is a sectional view of an evaporative emission control system according to the present invention with provisions for selectively heating the adsorbent towards the purge outlet using a heater separate from the particulate adsorbent bed.

FIG. 4 is a sectional view of an evaporative emission control system according to the present invention with provisions for selectively heating the adsorbent towards the purge outlet for increased working capacity in conjunction with selective heating towards the purge inlet for low bleed emissions under diurnal cycling conditions.

FIG. 5 is a sectional view of an evaporative emission control system according to the present invention with provisions for selectively heating the adsorbent towards the purge outlet for increased working capacity in conjunction with selective heating of an auxiliary adsorbent for low bleed emissions under diurnal cycling conditions.

FIG. 6 is a sectional view of an evaporative emission control system according to the present invention with provisions for selectively heating the adsorbent towards the purge outlet using a heater separate from the particulate adsorbent bed, in conjunction with selective heating of an auxiliary adsorbent for low bleed emissions under diurnal cycling conditions.

FIG. 7 is a graph for illustrating the vapor loading distribution of adsorbed vapors along the flow path of an evaporative emission control test canister after adsorption and after purge when operating under slow and rapid on-board refueling vapor recovery (ORVR) loading rates.

FIG. 8 is a graph illustrating the temperature distributions along the flow path of an evaporative emission control canister after adsorption and after purge when operating under slow and ORVR loading rates.

FIG. 9 is a graph for illustrating the vapor loading distribution of adsorbed vapors along the flow path of an evaporative emission control canister after adsorption and after purge when operating under normal and low purge volumes.

FIG. 10 is a graph illustrating the temperature distributions along the flow path of an evaporative emission control test canister after adsorption and after purge when operating under normal and low purge volumes.

FIG. 11 is a diagram schematically illustrating the testing equipment for adsorbing and desorbing n-butane.

FIG. 12 is a sectional view of a test canister of activated carbon according to an embodiment of the invention.

FIG. 13 is a sectional view along the line 2-2 of FIG. 12.

FIG. 14 is a sectional view of a test canister according to a comparative example of heating the purge inlet volume of adsorbent.

FIG. 15 is a sectional view along the line 3-3 of FIG. 14.

FIG. 16 is a graph showing the relationship between location along the vapor flow path and local adsorbent temperature in the test canister of Example 2 after adsorption and purge cycling with n-butane under normal and low purge volume conditions without the application of resistive heating to supplement vapor recovery during purge.

FIG. 17 is a graph showing the relationship between the locations of selective heating in a test canister of adsorbent with the relative effect of heating on n-butane working capacity as a function of purge volume.

FIG. 18 is a graph showing the relationship between location along the vapor flow path and local adsorbent temperature in the test canister shown in FIGS. 14 and 15 (Example 4) after adsorption and purge cycling with n-butane and with heat applied during purge steps under normal and low purge volume conditions.

FIG. 19 is a graph showing the relationship between location along the vapor flow path and local adsorbent temperature for Example 2 after adsorption and purge cycling with n-butane and with heat applied during purge steps under normal and low purge volume conditions.

### DESCRIPTION OF EMBODIMENTS

The disclosed invention relates to the use of selective heating before or during purge flow towards the purge outlet length of the vapor flow path in order to increase the working capacity of the adsorbent in the evaporative emission control system and to increase the useful service life of the evaporative emission control system for vapor recovery.

The adsorbents include activated carbon from a variety of raw materials, including wood, peat, coal, coconut, lignite, petroleum pitch, petroleum coke, coal tar pitch, fruit pits, nut shells, sawdust, wood flour, synthetic or natural polymer, and a variety of processes, including chemical and/or thermal activation, as well as inorganic adsorbents, including molecular sieves, porous alumina, pillared clays, zeolites, and porous silica, and organic adsorbents, including porous polymers. The adsorbents may be in granular, spherical, or pelletized cylindrical shapes, or may be extruded into special thin-walled cross-sectional shapes, such as hollow-cylinder, star, twisted spiral, asterisk, configured ribbons, or other shapes within the technical capabilities of the art. In shaping, inorganic and/or organic binders may be used. The adsorbent may be a monolith part with geometrically uniform or nonuniform flow channels of similar, different, or random widths. The “monolith” includes foams, woven and non-woven fibers, mats, blocks, and bound aggregates of particulates. The monolith may be formed by a combination of extrusion, molding, castings, layered, and “jellyroll” methods. The adsorbents may be incorporated into a canister as one or more in-series layers or separate chambers.

Heat inputs suitable for use in the present invention include, but are not limited to, internal and external resistive elements and conductive adsorbents. The heat input may be by an element separate from the adsorbent (i.e., non-contacted with adsorbents) or a substrate or layer on to which the adsorbent is attached or in physical contact. The adsorbent may be directly heated electrically by having appropriate resistivity from the combination of the natural resistivity properties of the adsorbent and by the addition of conductive or resistive additives and binders in the original preparation of the adsorbent and in the forming of the adsorbent into particulate or monolithic forms. The conductive component may be conductive adsorbents, conductive substrates, conductive additives and/or conductive binders. Furthermore, the conductive material may be added in adsorbent preparation, added in intermediate shaping process, and/or added in adsorbent shaping into final form. Any modes of heat input may be used in the present invention. These include, but are not limited to, heat transfer fluid, heat exchanger, and a heat conductive element. The amount of heat input may or may not be uniform along the heated vapor path length (i.e., different local intensities) and may or may not be distributed for greater intensity and duration of heating at different points along the heated vapor path length. The total vapor flow path is defined as the designed superficial path length for vapor flow through or past adsorbent, plus the designed superficial path length of vapor through, past, or around any heating element, exchanger, or device that may or may not have adjacent adsorbent, i.e., at the same vapor flow path length location, in or not in direct physical contact. The heated vapor path length is defined as the designed superficial path length of vapor flow through which heat input may be applied, whether containing adjacent adsorbent along the heated lengths or not.

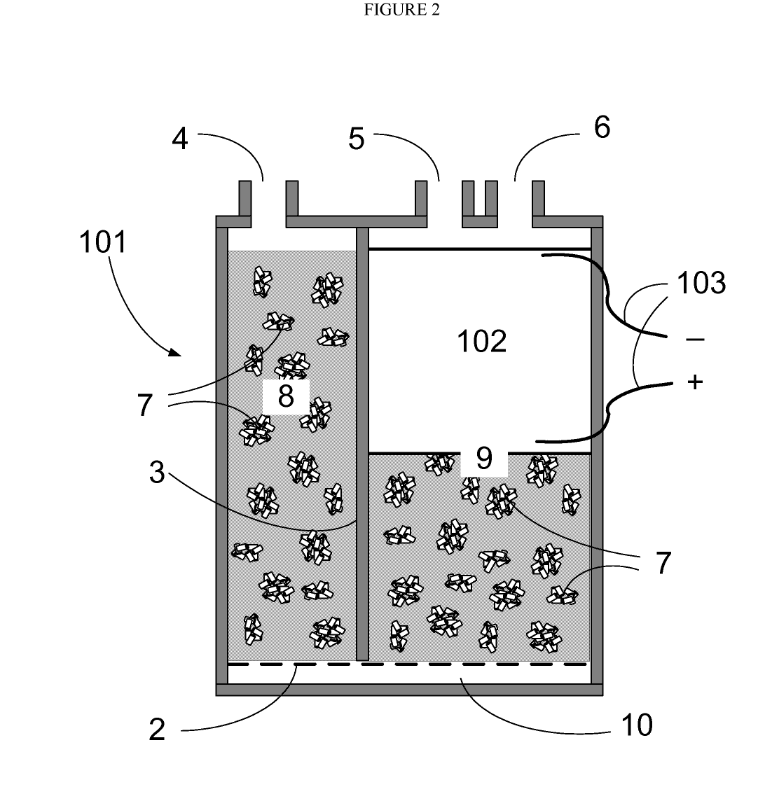

FIG. 2 illustrates a canister 101 for control of evaporative fuel emissions by the present invention. A volume of adsorbent towards the purge outlet 102 is heated by the flow of current through electrical leads 103 after fuel adsorption. The current flow may be applied before and during purge flow. The embodiment shown in FIG. 2 has a standard adsorbent 7 in the remainder of canister volume 9 that is entirely located upstream in the purge flow from the heated adsorbent 102. The adsorbent 7 in the purge inlet volume 8 of the canister may have different adsorptive and external dimensional properties, such as particle size, compared with the adsorbents selected for the purge outlet volume 9 of the canister. Adsorbent 7 located in a layer at the purge inlet of canister volume 8 may have different adsorptive and external dimensional properties than another adsorbent in-series and downstream in the purge flow within the canister volume 8. Another embodiment is to have the heated adsorbent 102 encompassing the entire flow path of canister volume 9. The heated adsorbent 102 may encompass the entire flow path of volume 9, a portion of volume 9 directly at the purge outlet, or a portion of volume 9 at a distance removed from the purge outlet.

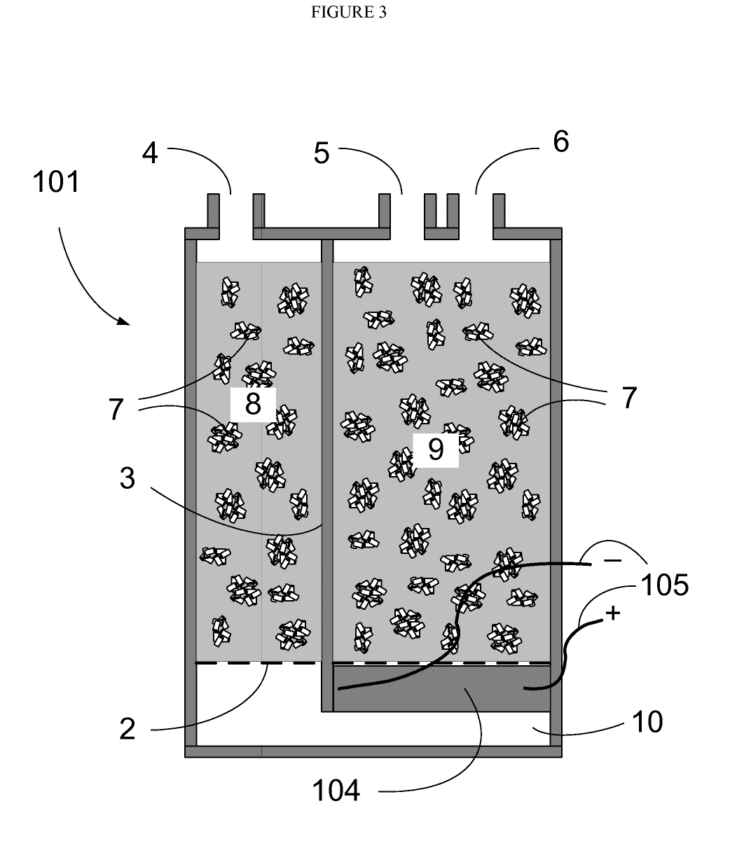

FIG. 3 illustrates a canister 101 for control of evaporative fuel emissions by the present invention whereby the mode of heat input is a nonadsorbent heater 104 without adsorbent adjacent to its location. The heater 104 shown in FIG. 3 is of the type that is electrically heated, with electrical leads 105 shown for power input. For example, heater 104 may be a positive temperature coefficient ceramic honeycomb or monolith. For the canister system shown in FIG. 3, the designed vapor path length through nonadsorbent heater 104, between the plenum 10 and the bottom of adsorbent bed 9 supported on the screen 2, is defined as the heated vapor path length according to the present invention and is as part of the total vapor path length.

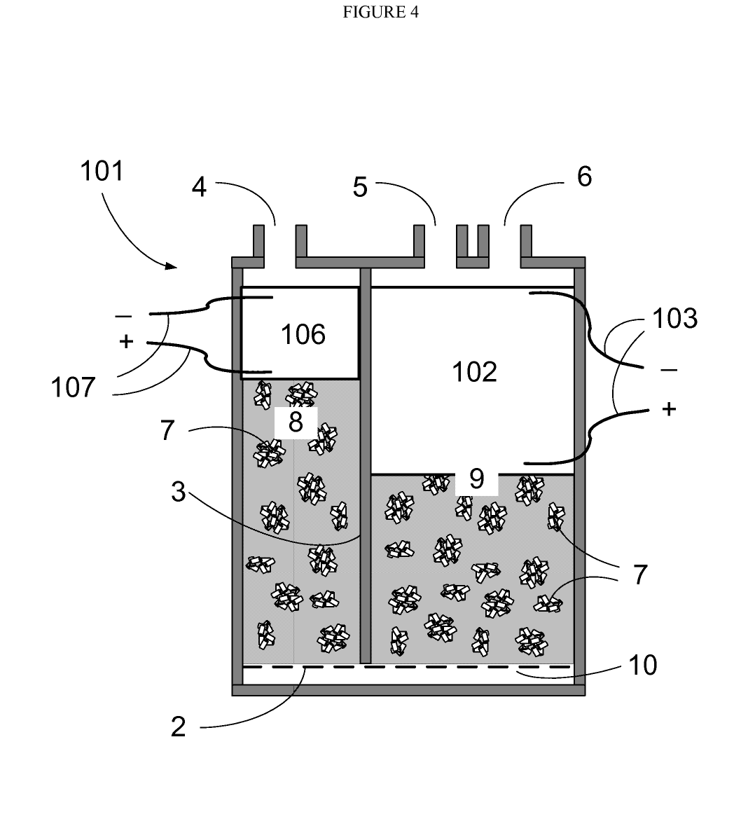

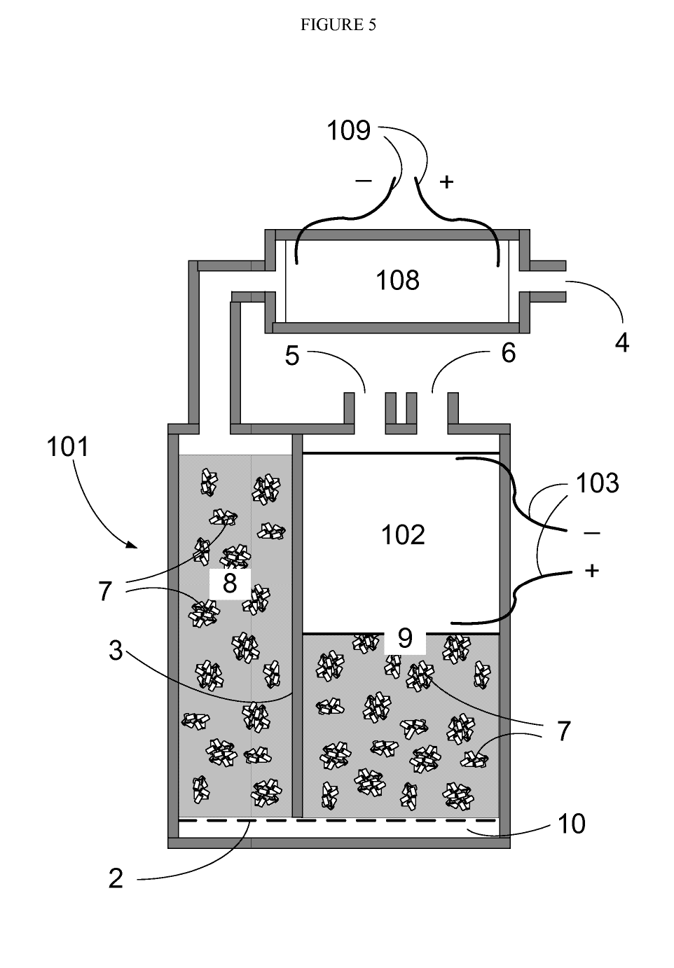

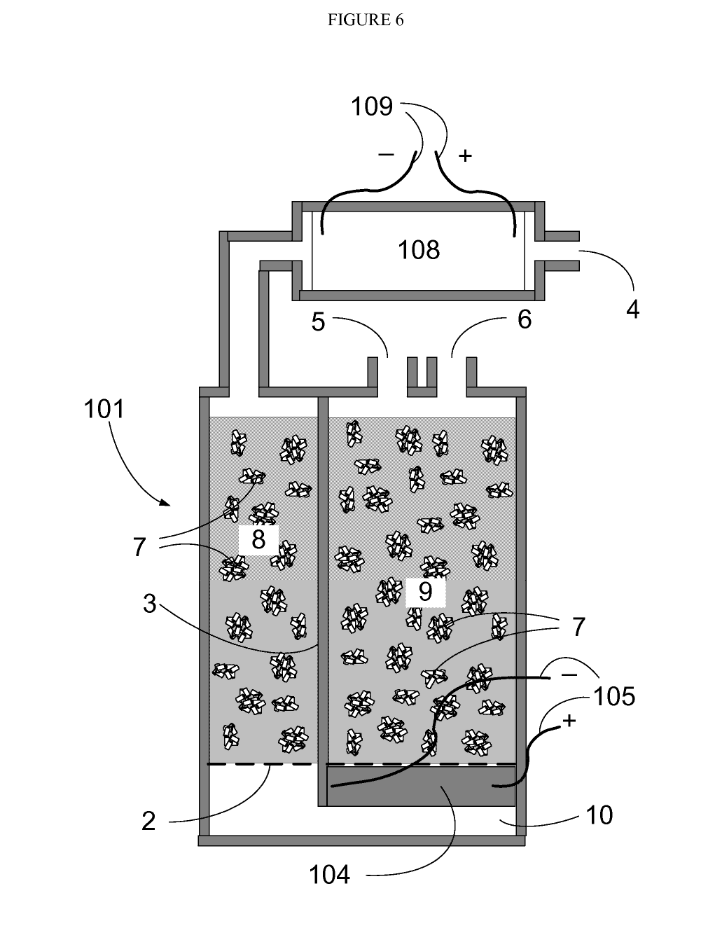

Known methods for attaining low bleed emissions performance under diurnal breathing loss conditions via passive and heated adsorbents may be employed at the purge inlet in combination with the present invention as the means for achieving both low emissions and increased working capacity. FIG. 4 is an embodiment of the present invention that includes a volume of adsorbent 106 located at the purge inlet that is heated by the flow of current from power source 107. FIGS. 5 and 6 are embodiments of the present invention with a volume of adsorbent 108 located in an auxiliary canister, heated by the flow of current from power source 109. The auxiliary canister may be placed in-series in purge flow with the main vapor recovery canister. The adsorbents in the auxiliary canister may be particulate form and/or monolith form of adsorbents. Additionally, ceramic-bound carbon honeycomb may be used an adsorbent in the auxiliary canister. For the canister system shown in FIG. 6, the designed vapor path length through nonadsorbent heater 104, between the plenum 10 and the bottom of adsorbent bed 9 supported on the screen 2, is defined as the heated vapor path length according to the present invention and is defined as part of the total vapor path length.

The benefits from selective heating within the adsorbent system for evaporative emissions control, specifically and preferably towards the purge outlet of the adsorbent bed, were discovered from studying residual vapor distribution, dynamic adsorption, convective cooling, and heat release along the vapor flow path. The special utility of selective heating is understood by sequentially reviewing how rates of vapor loading affect the adsorbent bed performance, how purge rates affect adsorbent bed performance, and how selective heating improves performance, especially for operation under low purge conditions.

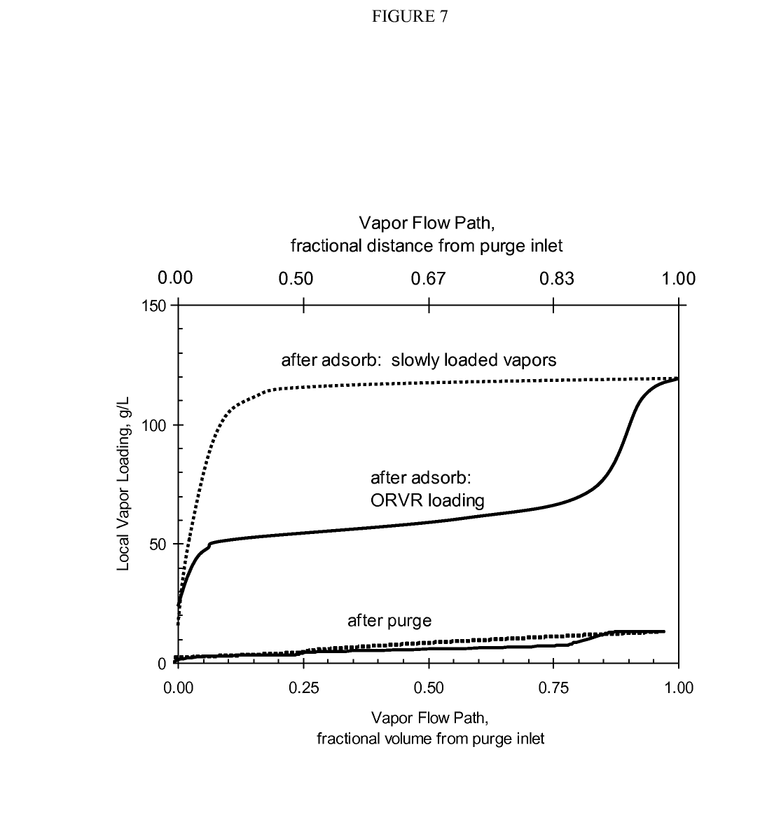

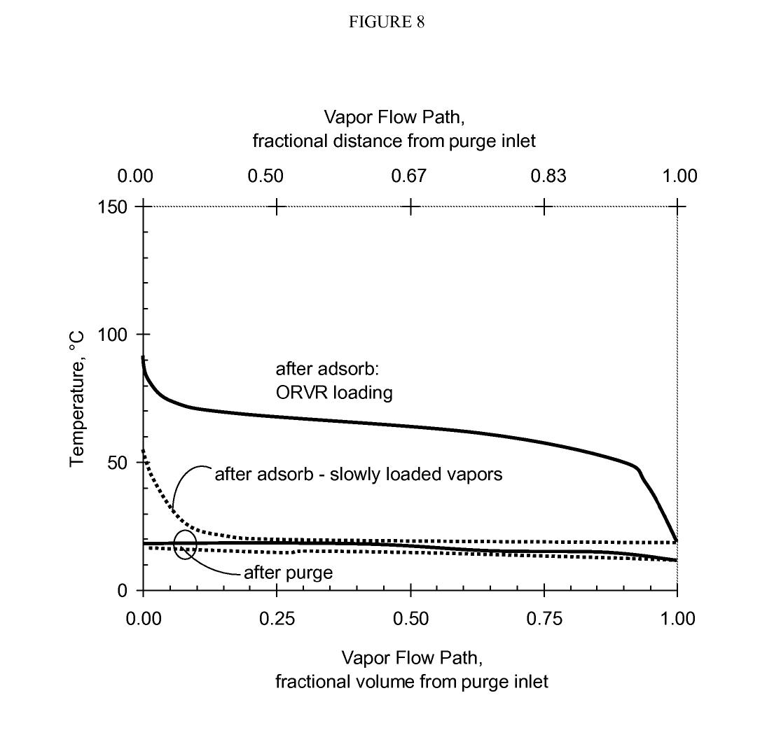

Vapor Rate Effects. Adverse effects of high vapor loading rates on adsorbent bed performance are demonstrated by comparing the operation of emission control systems for on-board refueling vapor recovery (ORVR) versus running losses or diurnal breathing losses. Adsorption for ORVR is a rapid vapor loading process relative to running loss and diurnal breathing loadings. For both uses, fuel vapors flow in the opposite direction along the flow path during the vapor adsorption step compared with purge flow, from the purge outlet to the purge inlet. Under ORVR conditions, fuel vapors are supplied at rates that are nearly two orders of magnitude faster due to the rapid displacement of vapors from the fuel tank during a refueling operation compared with the slow rates of vapor generated from running losses and diurnal breathing. FIG. 7 is a graph illustrating the relationship between local vapor loading on the adsorbent and location along the vapor flow path for a rapid vapor loading ORVR process and a slow loading process. FIG. 8 is a graph illustrating the relationship between adsorbent temperature and location along the vapor flow path. The “after purge” condition excludes a multi-hour “soak” period that occurs during the operation of the vehicle prior to the next refueling operation, and thereby allows the canister after each purge step to equilibrate to ambient temperature.

Under a slow loading of vapors where adsorption occurs over hours, conduction is a major mode of dissipation for the heat of adsorption from the canister. As a result, at the end of the adsorption step, the adsorbent is nearly saturated along the vapor flow path to the concentration and temperature of fuel vapors entering the canister. The exception to the near-saturated state is in the region towards the purge inlet where the mass transfer zone resides, active adsorption is underway (FIG. 7), and the adsorbent temperature is elevated from the heat of adsorption (FIG. 8). In contrast, during ORVR operation when the adsorption step is minutes in duration, there is little time for dissipation of the heat of adsorption from the canister via conduction. As a result, at the end of the adsorption step, temperatures along the middle length of the flow path are elevated and the loadings of adsorbed vapor are reduced. The lowest adsorbent temperatures and the highest local loadings of vapor at the end of the adsorption step are located at the purge outlet because the adsorbent at this location has had the greatest opportunity for convective cooling, e.g., the adsorbent has received its inlet gas flow at ambient temperatures and has had the most residence time at the highest total gas flow (air+vapor at or near the inlet vapor concentration). The purge outlet receives the highest total volumetric flow during adsorption steps because the sharp vapor concentration gradient of the mass transfer zone had already passed through this location and the location was then the recipient of nearly the full flow of the incoming vapor stream through the remaining duration of the adsorption step (less any incremental volume of vapors adsorbed as the location convectively cooled). In contrast, downstream locations along the flow path towards the purge inlet had received vapor laden air during the adsorption step that was warmed to temperatures above ambient from the upstream heat of adsorption, plus had less time and flow volume for dissipation of its own heat of adsorption. The highest temperatures in the canister over the adsorption steps are present at the purge inlet. The adsorbent at the purge inlet had been most thoroughly cleansed of captured vapors from the previous purge step because of the proximity to the vapor-free inlet purge flow and because of the typically restricted cross-sectional area at the purge inlet in common designs for canisters that enhances desorption of vapors. Therefore, of any location along the vapor flow path, the adsorbent at the purge inlet has the least amount of residual heel after the purge step to function as a heat sink for the heat of adsorption in the subsequent adsorption step, has the least time for heat dissipation via convection after passage of the mass transfer zone during the adsorption step, and has the least total volumetric flow for convective cooling during the adsorption step, having received nearly vapor-free air for the majority of the adsorption step.

It is notable that, although elevated temperatures are generally impediments to adsorption capacity, a higher temperature of a vapor-laden adsorbent at the end of an adsorption step gives a greater local concentration driving force for desorption during the subsequent purge step. The local driving force for desorption is defined as the difference between the concentration of vapor in the gas phase and the concentration of gas phase vapor that would be otherwise in equilibrium with vapors loaded in the adsorbent at the given vapor loading and adsorbent temperature, with a higher equilibrium gas phase concentration at higher temperatures. For example, soon after a refueling operation, it is common for a vehicle engine to return to operation (vehicle driven away from the fueling station) and to engage in a purge step, and thereby exploit the elevated temperature of the adsorbent to augment vapor desorption. The extent of the net benefit in working capacity from the elevated temperature is determined by whether there is sufficient purge volume for removal of the vapors from the evaporative emission control system.

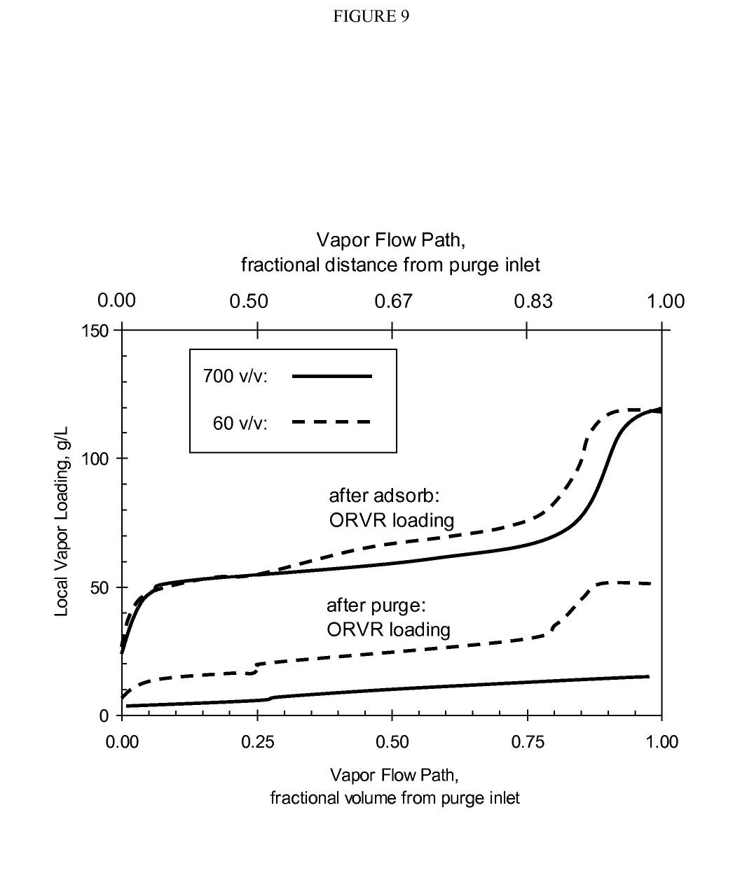

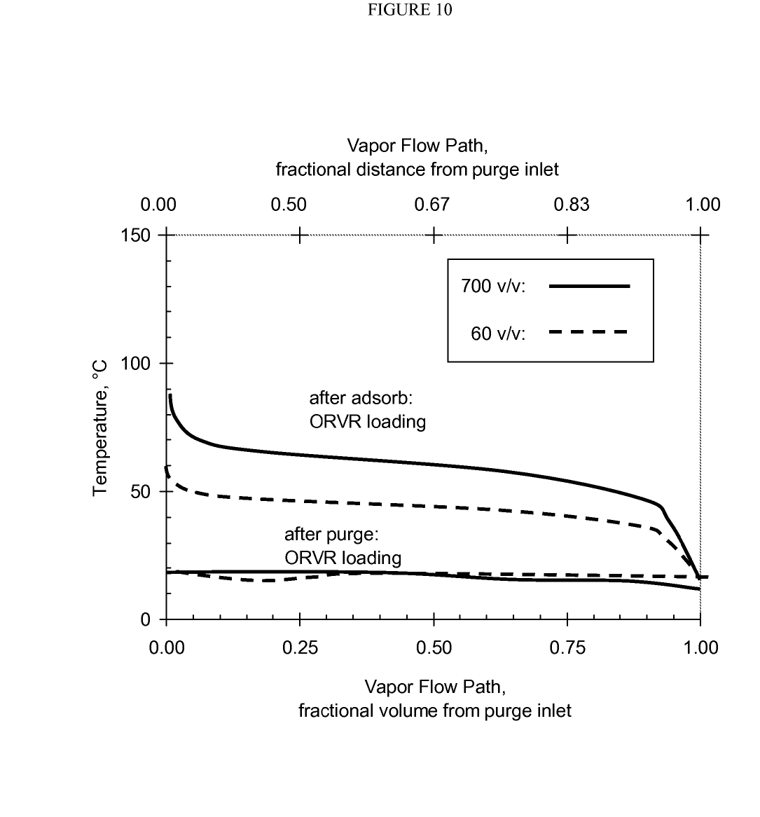

Purge Volume Effects. Vapor loadings and adsorbent temperatures for normal purge flow of 700 v/v and limited purge flow of 60 v/v are shown in FIGS. 9 and 10 for ORVR operation of the canister system, where v/v is the ratio of the total purge volume relative to the volume of adsorbent. By operating the evaporative emission control system under limited purge conditions, less of the adsorbed vapors are recovered during the purge steps compared with normal purge flow, leaving a greater amount of residual vapors along the flow path and lower temperatures along the flow path due to the greater heat sink for the heat of adsorption from the presence of the extra residual vapors in the adsorbent. Furthermore, under limited purge volume conditions, the residual loading of vapors, or “heel,” is distributed with a disproportionately greater amount located towards the purge outlet at the end of the purge step. The amount of vapor heel at the purge outlet is disproportionately greater when operating under limited purge conditions because the adsorbent at this location in the canister is exposed to high concentrations of vapors removed from locations upstream in the adsorbent bed throughout the purge step, without the benefit of exposure to purge flow with low concentrations of vapors as otherwise encountered under normal purge flow conditions or at locations in the canister closer to the purge inlet. Therefore, limited purge operation selectively reduces the local concentration driving force for vapor desorption at the purge outlet location of the canister, leading to a higher heel loading at this location. In addition, as an aftereffect of the previous purge step when operating under limited purge conditions, the extra heel accumulated at purge outlet provides a substantial heat sink for the heat of adsorption during the subsequent adsorption step, thereby enabling saturation at a lower temperature (FIG. 10) and, therefore, a higher loading of vapors further along the vapor flow path from the purge outlet (FIG. 9). The net result of limited purge under ORVR operation is that the adsorbent at the purge outlet has higher vapor loadings at the completion of the purge and adsorption steps as compared with loadings under normal purge volume operation.

Note that the extra inventory of vapors loaded along the flow path with the limited purge operation, especially at the purge outlet, are a potential source of recoverable vapors. However, these additional adsorbed vapors, particularly at the purge outlet, are not otherwise recovered in evaporative emission control systems operated for ORVR usage with limited purge volume because of the depressed temperature of the adsorbent, the lack of sufficient purge volume, and the suppressed concentration driving force for desorption.

Selective Heating Effects. An unexpected benefit was discovered by applying heat selectively towards the purge outlet of the adsorbent system during the purge step where the relatively low temperatures after adsorption are otherwise an impediment to vapor removal and where there is a relatively larger loading of vapors. The selective application of heat at the purge outlet has a benefit of increased working capacity, thereby allowing for design of smaller, more efficient heating functions within the adsorbent canister, especially for use in vehicles limited in purge volume and where space and electrical power are at a premium for such an auxiliary function in the evaporative emission control system. Furthermore, selective heating during each purge step would also limit the progressive contamination of the adsorbent with high boiling point components from the fuel vapor source by increasing the volatility of these components during each purge step, thereby reducing the retention of these components, enhancing the service life of the canister, and preventing deterioration of the required bulk recovery of vapors over the life of the vehicle. The enhancement of service life by selective heating at the purge outlet would also be effective under operation of the emission control system with a normal, high purge volume because the penetration of higher boiling point compounds is also present under operation with this purge volume and is initially limited to the region of the adsorbent first receiving incoming fuel vapors, i.e., towards the purge outlet.

In contrast with heating towards the purge outlet during purge, the prior art methods of heating towards the purge inlet were surprisingly found to be ineffective for increased recovery of vapors. The mode of heating the purge inlet is commonly taught for improved evaporative emission control in conventional vehicles and for newer engine designs that have low volumes of purge available. Cleaning the adsorbent of adsorbed vapors at the purge inlet by heating the incoming purge flow or by heating the purge inlet adsorbent will lower emissions from the canister system during diurnal breathing conditions. However, the net amount of vapor recovered is not appreciably increased when purge volumes are low unless exceedingly large amounts of heat are employed at the purge inlet in order to effectively raise the adsorbent temperature at the opposite, purge outlet end of the vapor flow path. Apparently, modest amounts of heat input, e.g., a few amperes at 12 volts DC, may increase the removal of adsorbed vapors at the purge inlet, but the extra vapors in the purge flow will depress the driving force for desorption along the downstream flow path, compromising any net increase in working capacity for the canister. The suppressed driving force for desorption is expected to be greatest under low purge operation because there is less dilution of desorbed gas phase vapors because of less volume of purge air passing through the bed. In addition, by limiting the heat input to the purge inlet to 35 W (a few amperes at 12 VDC), the useful life of the canister for vapor recovery would not be improved because the build-up of higher boiling point vapor components at the opposite end of the vapor flow path would be unaffected, again, unless more heat is added at the purge inlet in order to affect the temperature of the adsorbent at the opposite end of the vapor flow path, towards the purge outlet.

The prior art methods of heating along the full canister length is wasteful of space and energy input because heating of the first half of the flow path distance has minimal benefit to vapor recovery, particularly when low volumes of purge are available. The conventional wisdom behind these prior inventions of having heat input along the full flow path length is that heating at all locations is beneficial; however, the work associated with the current invention has revealed that the application of heat at only some locations has benefits to canister performance, particularly when the amount of purge is limited and a realistically modest amount of heat is available. For the same effect on working capacity performance, heating devices would be smaller and energy input would be less if the heating function is selectively applied, such as minimized towards the purge inlet and selectively placed towards the purge outlet, allowing for greater use of conventional adsorbents with high working capacity properties in the unheated volume of the canister, and requiring less materials, less space, and potentially less total power input for the heaters and the heating components. Some selective application of heat at the purge inlet may be useful for lowering diurnal breathing loss emissions, yet would not be expected to usefully increase working capacity or working capacity-related service life.

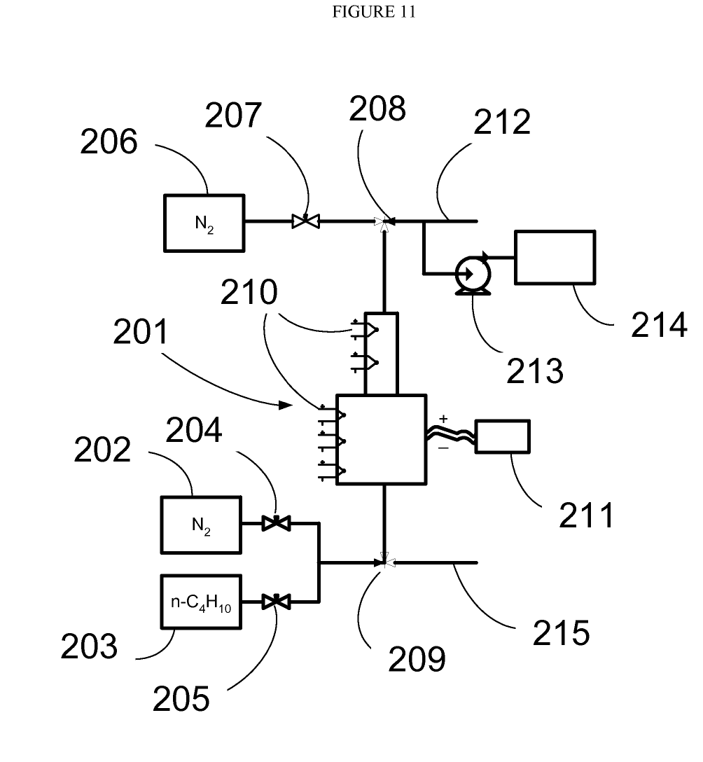

The increase in working capacity of the invention evaporative emission canister was demonstrated by conducting adsorption and purge experiments with n-butane and a canister containing 1500 cc of activated carbon pellets and a 500 cc activated electrically conductive carbon honeycomb module that could be heated by applying electrical current. The n-butane (n-C₄H₁₀) vapor was selected for quantifying working capacity because it is representative of low boiling point components in gasoline fuel vapors. FIG. 11 is a diagram schematically illustrating the test equipment with the test canister 201. The vapor laden gas stream that simulated the flow of displaced vapors from a fuel tank during a refueling operation was generated by mixing gas flows from a nitrogen supply 202 and n-butane supply 203 via needle valves 204 and 205 and a joining tubing tee. The purge flow was generated by metering nitrogen gas 206 with a needle valve 207. A pair of three-way pneumatic ball valves 208 and 209, in appropriate positions, supplied either the butane-laden nitrogen up through the canister 201 for adsorption steps or nitrogen flow down through the canister 201 for purge steps. The canister 201 was equipped with thermocouples 210 for measuring centerline temperatures in the flow path and was equipped with a DC power supply 211 that enabled 35 W input to the carbon honeycomb module in canister 201. During adsorption steps, a 21 L/min flow of nitrogen 202 was blended with 20 L/min flow (49 g/min) of n-butane 203, with the three-way valves 208 and 209 positioned to enable flow through the canister 201 and out the effluent line 212. A slip stream from the effluent line 212 was sampled by a diaphragm pump 213 and tested for n-butane concentration by a hydrocarbon analyzer 214. When the effluent concentration of n-butane during adsorption exceeded 0.5 vol % (1% of the influent concentration), the three-way valves 208 and 209 were repositioned to cut off the n-butane laden nitrogen flow and to start the purge step with flow from nitrogen source 206 and out the vent 215. Purge was applied for 20 minutes with the flow rate adjusted by valve 207 in order to attain the desired total purge volume over the duration of the purge step relative to the total volume of the adsorbent in canister 201 as defined by volumes 307-310 (“v/v” ratio). The DC power supply 213 was operated for the full 20 minutes of the purge flow when selective heating within the canister 201 was desired. Incoming gas and vapor flows and the ambient temperature were maintained at 21±1° C. Before the next adsorption step and after the completion of the 20 minute purge flow, the canister 201 was maintained in a two hour “soak” step without any incoming flows. The purpose of the soak step was to simulate the near-static state of an evaporative emission control canister prior to the next refueling operation. During the soak step, the adsorbent re-equilibrated to ambient temperature via conduction of heat through the walls of canister 201. The canister 201 was weighed after adsorption steps and purge steps, with the difference of the two values determining the working capacity for n-butane expressed as grams or grams/liter-adsorbent. Approximately eight repeated cycles of adsorption, purge, and soak were required for the working capacity to reach steady state, defined as a variability of less than ±0.0-0.6 g/L in working capacity among successive values in deriving steady state data.

### Example 1

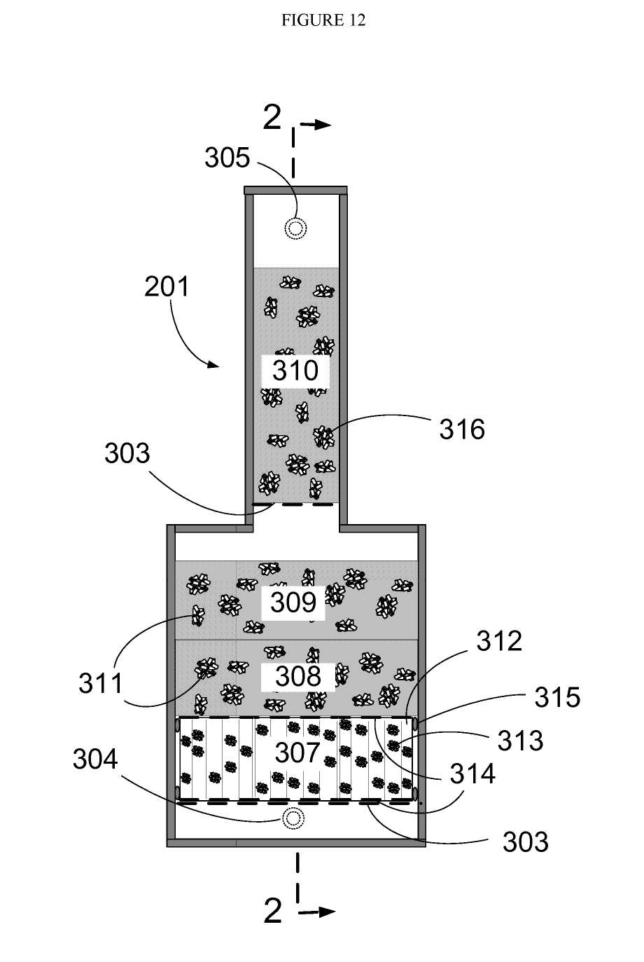

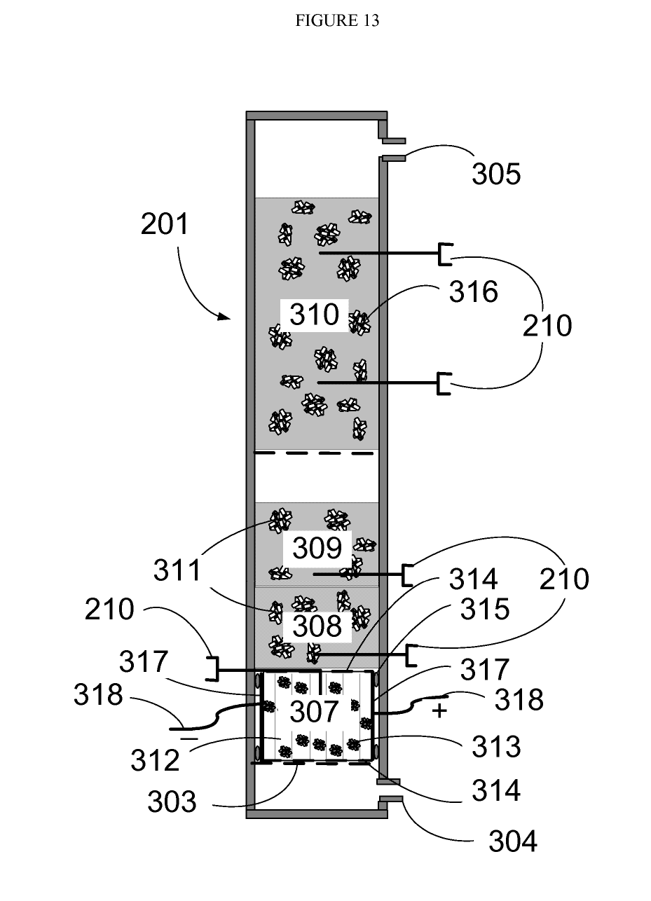

A canister 201 was fabricated from Plexiglas® (FIGS. 12 and 13) and was equipped with screens 303 for retaining adsorbent, a purge outlet (adsorption step vapor source inlet) port 304 connected to three-way valve 209, a purge inlet (adsorption step exhaust outlet) port 305 connected to three-way valve 208, and activated carbon adsorbents in volumes 307-309 with a cumulative vapor flow path length of 17 cm and volume 310 with a vapor flow path length of 17 cm. The purge outlet section consisted of a 500 cc volume 307 filled by an activated carbon monolith module. Volume 307 encompassed the adsorbent flow path from 83% to 100% of the fractional distance from the purge inlet, or 75-100% of the fractional adsorbent volume from the purge inlet. Volumes 308 and 309 were each filled with 500 cc of 1.6 mm carbon pellets 311 made by phosphoric acid activation according to the method described in U.S. Pat. No. 5,324,703. Volume 308 encompassed the adsorbent flow path from 67% to 83% of the fractional distance from the purge inlet, or 50-75% of the fractional adsorbent volume from the purge inlet. Volume 309 encompassed the flow path from 50% to 67% of the fractional distance of adsorbent from the purge inlet, or 25-50% of the fractional adsorbent volume from the purge inlet. The activated carbon monolith module in volume 307 consisted of three electrically conductive activated carbon honeycomb blocks 312 with a cell density of 23 cells per sq. inch that were made according to the method described in U.S. Pat. No. 5,914,294, and adjoined together side-by side as a module to encompass the width of volume 308 shown in FIG. 12, with cells parallel to the vapor flow path. The cells of the honeycombs 312 were filled with 1.2 mm carbon pellets 313 made from phosphoric acid activation according to the method described in U.S. Pat. No. 5,324,703. The pellets 313 were retained in the honeycomb blocks 312 by nonconducting polymer-coated glass fiber screens 314 placed above and below the honeycomb blocks 312. The seal between honeycombs 312 and the interior walls of canister 201 was made with a Teflon® gasket 315. Volume 310 was filled with 500 cc of 2.7 mm pellets 316 made from phosphoric-activated activated carbon according to the method described in U.S. Pat. No. 6,573,212. Volume 310 encompassed the adsorbent flow path for the first 50% of the fractional distance from the purge inlet, or the first 25% of the fractional adsorbent volume from the purge inlet. The carbon module in volume 307 was equipped with copper foil 317 adhered to two opposing sides of the carbon honeycombs 312 with conductive adhesive (FIG. 13). Electrical leads 318 were attached to the copper foil and connected to DC power source 211 for application of 35 W of electrical power when desired. Volumes 307-310 had thermocouples 210 located along the centerline of the vapor flow path. The vapor flow path length for Example 1 is 34 cm, equal to the combined superficial flow path lengths through volumes 307-309 and volume 310. The 5.7 cm superficial flow path length for volume 307 is the heated flow path length of Example 1. If a nonadsorbent heater was placed between volumes 307 and 308, then the toal flow path and the subset of the heated flow path would include the length of the superficial vapor flow path across or through that heater.

The butane loading data after adsorption and after purge and the working capacity data for the Example 1 canister are provided in Table I.

TABLE I

| | | | Butane Loading | | | |
|---|---|---|---|---|---|---|
| | Purge | | After | After | Working | Effect of Heat |
| Heated | Volume | Purge | Adsorb | Purge | Capacity | at the Same |
| Volume | v/v | Heat | g/L | g/L | g/L | Purge Volume |
| 307 | 59 | 0 | 108.4 | 72.5 | 35.9 | — |
| 307 | 59 | 35 W | 99.6 | 59.3 | 40.3 | +12.3% |
| 307 | 125 | 0 | 94.6 | 52.2 | 42.4 | — |
| 307 | 125 | 35 W | 89.3 | 43.1 | 46.1 | +8.9% |

TABLE II

| | | | Butane Loading | | | |
|---|---|---|---|---|---|---|
| | Purge | | After | After | Working | Effect of Heat |
| Heated | Volume | Purge | Adsorb | Purge | Capacity | at the Same |
| Volume | v/v | Heat | g/L | g/L | g/L | Purge Volume |
| 308 | 59 | 0 | 109.4 | 73.9 | 35.5 | — |
| 308 | 59 | 35 W | 99.6 | 58.5 | 41.1 | +15.9% |
| 308 | 125 | 0 | 95.5 | 52.5 | 43.0 | — |
| 308 | 125 | 35 W | 89.0 | 40.0 | 49.0 | +14.0% |
| 308 | 728 | 0 | 74.7 | 19.4 | 55.2 | — |
| 308 | 728 | 35 W | 74.7 | 17.1 | 57.6 | +4.3% |

### Example 2

The construction of canister 201 was the same as that described for Example 1, except that the volumes 307 and 309 each contained 500 cc of 1.6 mm activated carbon pellets 311. Volume 308 contained the activated carbon monolith module. The butane loading data after adsorption and after purge and the working capacity data for the Example 2 canister are provided in Table II.

### Example 3

The construction of canister 201 was the same as that described for Example 1, except that the volumes 307 and 308 each contained 500 cc of 1.6 mm activated carbon pellets 311. Volume 309 contained the activated carbon monolith module. The butane loading data after adsorption and after purge and the working capacity data for the Example 3 canister are provided in Table III.

TABLE III

| | | | Butane Loading | | | |
|---|---|---|---|---|---|---|
| | Purge | | After | After | Working | Effect of Heat |
| Heated | Volume | Purge | Adsorb | Purge | Capacity | at the Same |
| Volume | v/v | Heat | g/L | g/L | g/L | Purge Volume |
| 309 | 59 | 0 | 106.7 | 72.2 | 34.4 | — |
| 309 | 59 | 35 W | 100.7 | 62.2 | 38.5 | +11.8% |
| 309 | 125 | 0 | 96.0 | 52.2 | 43.7 | — |
| 309 | 125 | 35 W | 89.8 | 42.5 | 47.2 | +8.0% |
| 309 | 728 | 0 | 80.0 | 24.6 | 55.4 | — |
| 309 | 728 | 35 W | 73.7 | 15.4 | 58.3 | +5.2% |

### Example 4

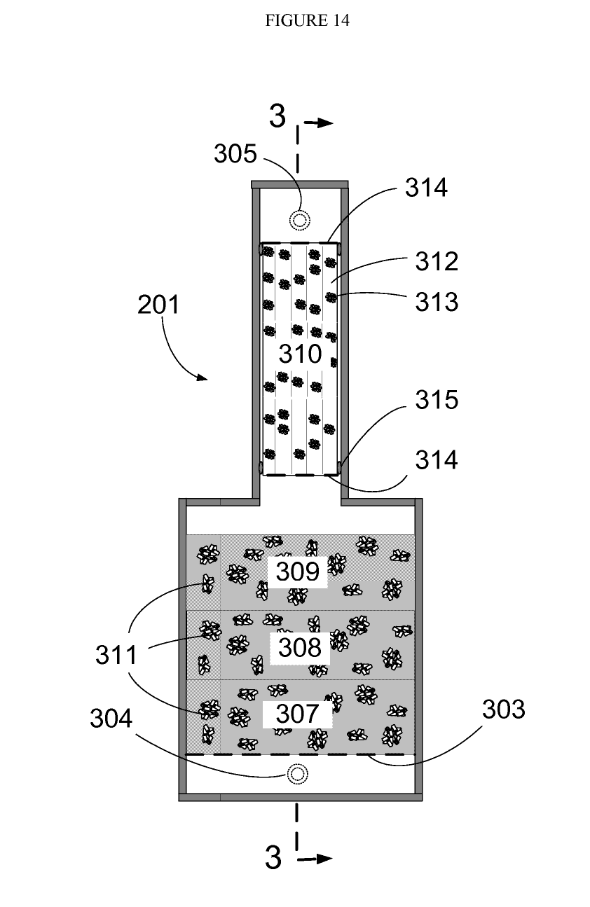

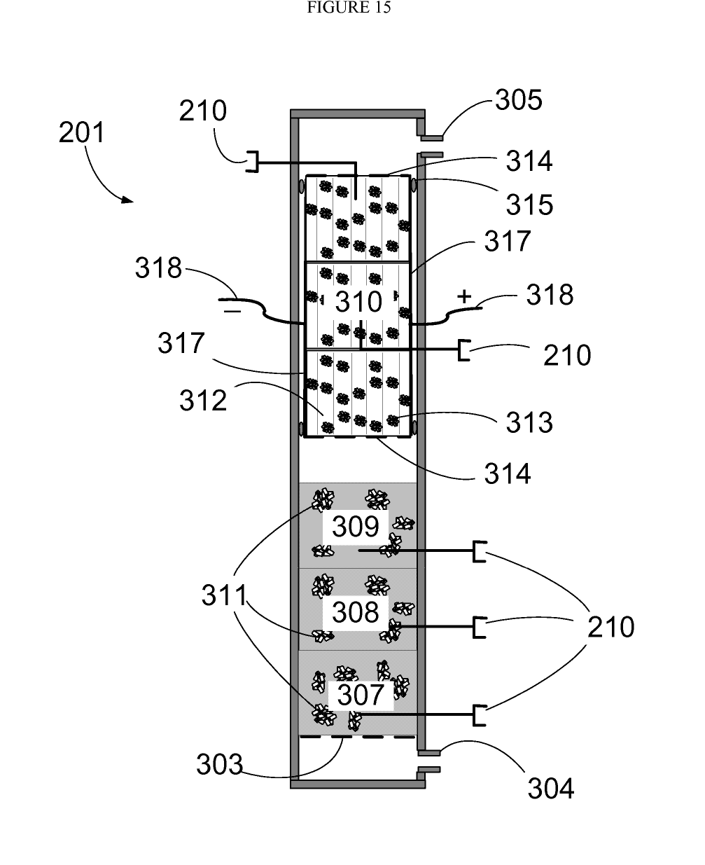

The construction of canister 201 was the same as that described for Example 1, except that volumes 307-309 each contained 1.6 mm activated carbon pellets 311, and volume 310 contained the activated carbon honeycomb module (FIGS. 14 and 15). The components of the module were identical to that described for Examples 1-3, except that the three activated carbon honeycomb blocks 312 were placed in a vertical stacked configuration, with the internal cells aligned parallel with the vapor flow path. Thermocouples 210 were placed with centerline cells in the module contained in volume 310. The butane loading data after adsorption and after purge and the working capacity data for the Example 4 canister are provided in Table IV.

TABLE IV

| | | | Butane Loading | | | |
|---|---|---|---|---|---|---|
| | Purge | | After | After | Working | Effect of Heat |
| Heated | Volume | Purge | Adsorb | Purge | Capacity | at the Same |
| Volume | v/v | Heat | g/L | g/L | g/L | Purge Volume |
| 310 | 59 | 0 | 96.6 | 63.5 | 33.1 | — |
| 310 | 59 | 35 W | 92.3 | 59.5 | 32.8 | −0.9% |
| 310 | 125 | 0 | 82.6 | 43.2 | 39.4 | — |
| 310 | 125 | 35 W | 81.3 | 41.2 | 40.2 | +2.0% |
| 310 | 728 | 0 | 67.1 | 19.6 | 47.5 | — |
| 310 | 728 | 35 W | 62.3 | 12.4 | 50.0 | +5.2% |

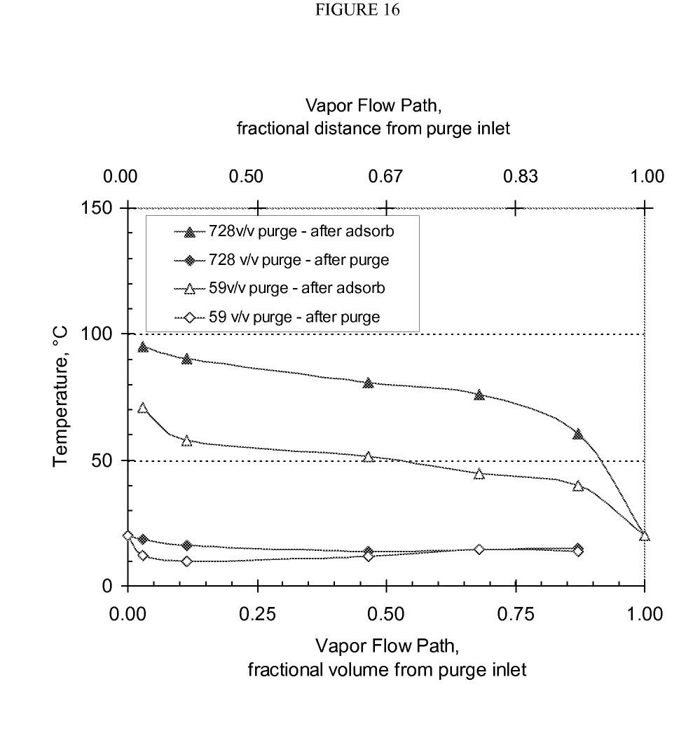

Effects of Purge Volume without Applied Heat. Tables I-IV have data for no heat added during the purge steps. Lowering the purge volumes to 125 and then to 59 v/v left greater amounts of adsorbed vapors after the adsorption step and yet even greater amounts of residual heel of vapors after the purge step, for the net reductions in working capacity from less purge volume. FIG. 16 has data for Example 2 showing the typical effects of purge volume on temperature profiles after adsorption and purge steps. The experimental temperature profiles in FIG. 16 after purge cycles are consistent with the nonuniform temperature profiles shown in FIG. 10 and are consistent with nonuniform loadings of vapors across the vapor path length. Lower temperatures are present after adsorption steps when operating under lower purge volumes and are attributed to greater loadings of vapors that function as a heat sink. The lowest temperatures for a particular purge volume operation are located at the purge outlet, consistent with greater loadings of vapors at that location. The distribution of temperatures along the flow path after the adsorption step, particularly the lower temperatures towards the purge outlet, are significant as they indicate the effects of the ambient temperature of the influent flow of vapor-laden air, the added convective cooling from more local total flow volume at the purge inlet, and the greater local amount of heat sink present towards that end of the purge flow path. These data support the assertion that added heat during purge flow would be preferentially beneficial if placed towards the purge outlet particularly when operating under limited purge volume, thereby enhancing removal of vapors accumulated towards the purge outlet that are otherwise hindered from desorbing by a suppressed concentration driving force.

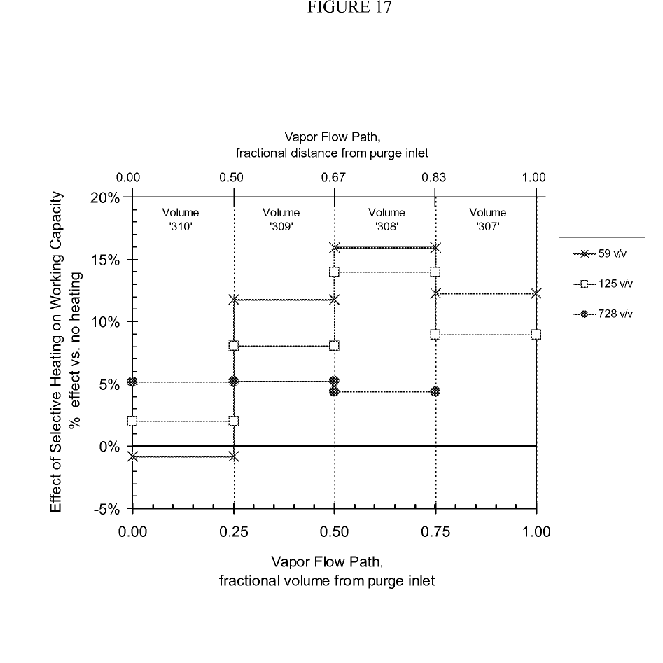

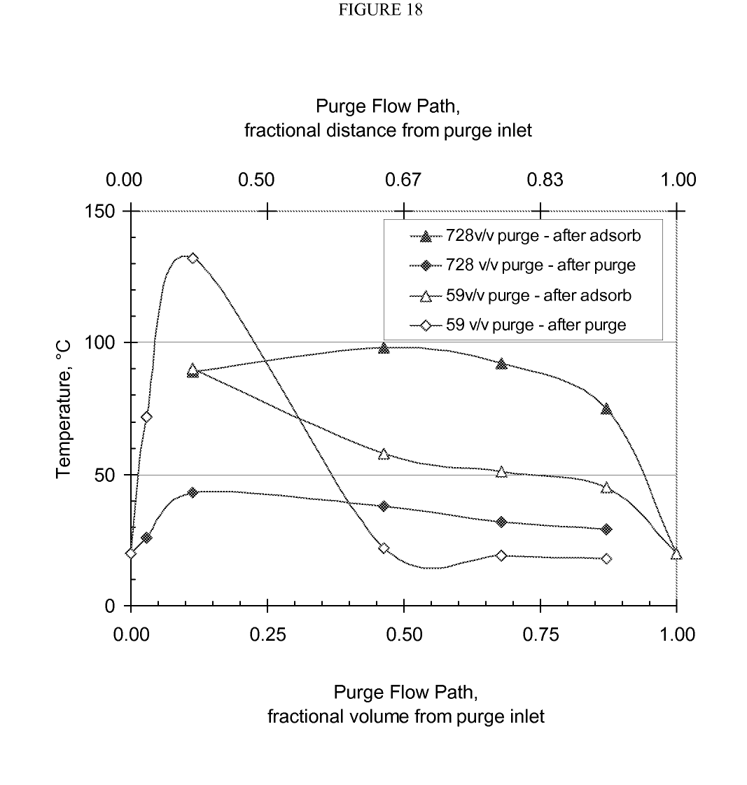

Selective Heating Effects. The summarized data for the effects of selective heating on working capacity as a function of heating location and purge volume are provided in FIG. 17. Heating of volume 310, the adsorbent at the purge inlet and the first 50% length or 25% volume of the total vapor flow path, had a modest 5% increase in working capacity under normal purge volume operation (728 v/v for Example 4, Table IV) when the 35 W of power was applied during purge flow. However, as purge volume was decreased to 125 v/v, and further decreased to 59 v/v, the modest increase in working capacity from heating the purge inlet surprisingly disappeared at the lowest purge volume. The explanation for the loss in benefit from prior art mode of selectively heating the purge inlet as less purge volume was used is that residual heel after the purge step was indeed reduced in the purge inlet volume 310, and possibly in the adsorbent immediately downstream due to warmed purge volume (FIG. 18). However, the passage of additional desorbed vapors from the heating of the adsorbent at the purge inlet further hindered the downstream desorption of vapors in a large fraction of the canister adsorbent, volumes 307-309. Although applying heat to the adsorbent volume at the purge inlet likely removed additional vapors from that location, the net reduction in heel for the entire canister was small and the net increase in working capacity was near zero for operation under limited purge volume.

Note that, under the 59 v/v purge conditions, there was little utilization of the upstream heat in raising the temperature of the adsorbent towards the purge outlet for driving out the vapors that normally accumulate at that point in the canister flow path (FIG. 18). In addition, by not increasing adsorbent temperature at the purge outlet, the heating of the purge inlet with a modest amount of energy would not be expected to increase the desorption of fuel vapors with higher boiling points than that of n-butane that are known to accumulate towards the purge outlet and diminish canister capacity over its service life.

In contrast with heating the purge inlet, substantial increases in working capacity were obtained under low purge volume operation by selectively heating the adsorbents towards the purge outlet, such as in volumes 307, 308, or 309. Modest 4-5% increases were obtained by heating at normal purge volumes (728 v/v), however, there was a surprising further enhancement in working capacity from selective heating towards the purge outlet as purge volume was reduced to 125 v/v, and further enhanced at 59 v/v purge, as tested for volumes 307, 308, or 309 in Examples 1-3 (Tables I-III and FIG. 17).

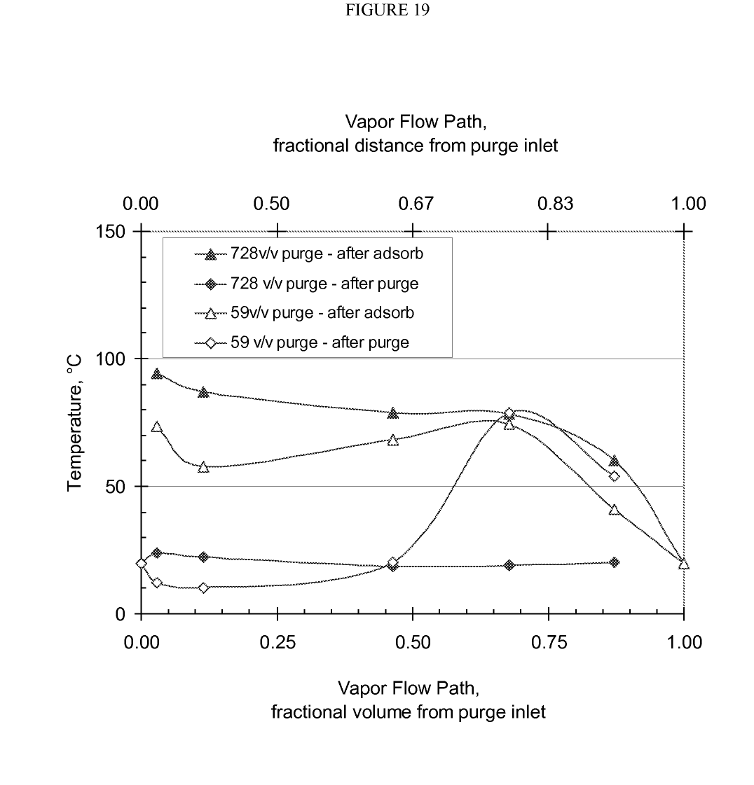

A location for increased working capacity from selective heating may be near, but not at, the purge outlet, such as volume 308. By selectively heating towards the purge outlet, there is no volume of adsorbent far removed from the heating location to have its vapor desorption substantially hindered by the additional desorbed vapors and there is benefit from the heated purge flow increasing the temperature of downstream adsorbent. For example, when heat is applied at the volume 308 location, the additional desorbed vapors from the heat input are in close proximity to the canister purge outlet. Therefore, any reductions in the downstream concentration driving force from the extra purged vapors are limited to a small remaining fraction of the purge flow path. In addition, the presence of some adsorbent downstream from the heat input allows some use of the convective heat leaving volume 308 for aiding vapor desorption from the downstream, purge outlet volume 307. The data in FIG. 19 shows this effect for the heating applied to volume 308. After the subsequent adsorption step, the temperature in volume 308 was elevated to the 80° C. level attained at normal 728 v/v purge volume, indicative of comparable adsorption at this location even though the purge volume was substantially lower at 59 v/v. Furthermore, it is expected that heating of adsorbent towards the purge outlet, even somewhat removed from the outlet as with volumes 308 or 309, would increase the desorption of fuel vapors with higher boiling points than that of n-butane that accumulate towards the purge outlet, thereby giving an increase in bed life for the mixture of vapors emanating from a multicomponent fuel such as gasoline.

The foregoing description relates to embodiments of the present invention, and changes and modifications may be made therein without departing from the scope of the invention as defined in the following claims.

We claim:

1. A method for increasing working capacity and maintaining working capacity over a service life of automotive evaporative emissions control systems comprising steps of:
(i) contacting a purge flow through adsorbents unheated along a portion of a purge inlet of a vapor flow path length of the adsorbents; and
(ii) contacting the purge flow through heated element along a purge outlet of the vapor flow path length of the adsorbents, wherein the heated element comprises at least one member selected from the group consisting of heater located in the plenum, heated plenum, heated adsorbent, and combinations thereof.

2. The method of claim 1, wherein the purge inlet comprises at least one member selected from the group consisting of a path length with the main vapor recovery canister and an auxiliary canister in-series in purge flow with the main vapor recovery canister.

3. The method of claim 2, wherein the auxiliary canister includes at least one adsorbent selected from the group consisting of particulate form, monolith form, and combinations thereof.

4. The method of claim 2, wherein the auxiliary canister includes ceramic-bound carbon honeycomb adsorbent.

5. The method of claim 1, wherein the adsorbent comprises at least one member selected from the group consisting of zeolites, porous silicas, porous aluminas, pillared clays, molecular sieves, porous polymers, activated carbons, and combinations thereof.

6. The method of claim 5, wherein precursor of the activated carbon comprises at least one material selected from the group consisting of wood, peat, coal, coconut, lignite, petroleum pitch, petroleum coke, coal tar pitch, fruit pits, nut shells, sawdust, wood flour, synthetic polymer, and natural polymer having been activated by a process selected from the group consisting of chemical, thermal, and combined chemical/thermal activation methods.

7. The method of claim 1, wherein the adsorbent comprises at least one type of adsorbents.

8. The method of claim 1, wherein the adsorbent comprise at least one member selected from the group consisting of particulate form, monolith form, and combinations thereof.

9. The method of claim 8, wherein the particulate adsorbent comprises at least one member selected from the group consisting of irregular granular shapes, spherical shapes, cylindrical shapes, and combinations thereof.

10. The method of claim 8, wherein the monolith adsorbent comprises at least one form selected from the group consisting of extruded honeycomb with parallel cell passages, layered sheets with parallel passages, jelly-rolled sheets with parallel cell passages, bound aggregates of particulates with randomly distributed voidages for vapor flow, and combinations thereof.

11. The method of claim 1, wherein the heat input comprises at least one member selected from the group consisting of electrical resistance heaters, positive temperature coefficient ceramics, heat exchange, heat transfer fluid, and combinations thereof.

12. The method of claim 1, wherein the heat input comprises at least one member selected from the group consisting of heaters located external to the adsorbent volumes, heaters internal to the adsorbent volumes, electrically conductive adsorbent volumes with heat applied by electrical current flow, and combinations thereof.

13. The method of claim 12, wherein the heat input internal to the adsorbent volumes comprises at least one member selected from the group consisting of heaters in non-bonded contact with adsorbents, and heaters in bonded contact with the adsorbents.

14. The method of claim 12, wherein the electrically conductive adsorbent volume component comprises at least one conductive material selected from the group consisting of conductive adsorbents, conductive substrates, conductive additives, conductive binders, and combinations thereof

15. The method of claim 14, wherein the conductive component material is added at a step comprising at least one member selected from the group consisting of adsorbent preparation step, intermediate adsorbent shaping step, final adsorbent shaping step, and combinations thereof.

16. The method of claim 1, wherein the heat input along the purge outlet flow path has same intensity throughout the path or has different local intensities.

17. The method of claim 1, wherein the heat input comprises at least one member selected from the group consisting of heat applied after adsorption prior to purge flow and heat applied during purge flow.

18. An evaporative emissions control system for a vehicle comprising, in combination, a fuel tank for storing a volatile fuel, an engine having an air induction system and adapted to consume the fuel, a canister containing an initial volume of fuel vapor adsorbent material for temporarily adsorbing and storing fuel vapor from the tank, a conduit for conducting fuel vapor from the tank to a canister vapor inlet, a fuel vapor purge conduit from a canister purge outlet to an induction system of the engine, and a vent/air opening for venting the canister and for admission of air to the canister during operation of the engine induction system, wherein the canister is defined by a fuel vapor flow path via the canister vapor inlet through an initial volume of vapor adsorbent within a first region of the canister toward the vent/air opening, and an air flow path through a subsequent volume of adsorbent within a second region of the canister at the vent/air opening and the first region at the purge outlet, such that fuel vapor formed in the tank flows through the vapor inlet into the initial volume of adsorbent where it is adsorbed and, during operation of the engine induction system, ambient air flows in a path to and through the vent/air opening and along the air flow path in the canister through the initial volume and the purge outlet to the induction system of the engine, the flow of air removing a portion of the adsorbed fuel vapor but leaving a residue of fuel in the initial volume, and wherein:
(i) the purge flow is subjected through unheated adsorbents along a portion of the purge inlet of the vapor flow path length of the adsorbents; and
(ii) the purge flow is subjected through heated element along the purge outlet of the vapor flow path length of the adsorbents, wherein the heated element comprises at least one member selected from the group consisting of heater located in the plenum, heated plenum, heated adsorbent, and combinations thereof.

19. The system of claim 18, wherein the purge inlet comprises at least one member selected from the group consisting of a path length with the main vapor recovery canister and an auxiliary canister in-series in purge flow with the main vapor recovery canister.

20. The system of claim 19, wherein the auxiliary canister includes at least one adsorbent selected from the group consisting of particulate form, monolith form, and combinations thereof.

21. The system of claim 19, wherein the auxiliary canister includes ceramic-bound carbon honeycomb adsorbent.

22. The system of claim 18, wherein the adsorbent comprises at least one member selected from the group consisting of zeolites, porous silicas, porous aluminas, pillared clays, molecular sieves, porous polymers, activated carbons, and combinations thereof.

23. The system of claim 22, wherein precursor of the activated carbon comprises at least one material selected from the group consisting of wood, peat, coal, coconut, lignite, petroleum pitch, petroleum coke, coal tar pitch, fruit pits, nut shells, sawdust, wood flour, synthetic polymer, and natural polymer having been activated by a process selected from the group consisting of chemical, thermal, and combined chemical/thermal activation methods.

24. The system of claim 18, wherein the adsorbent comprises at least one type of adsorbents.

25. The system of claim 18, wherein the adsorbent comprise at least one member selected from the group consisting of particulate form, monolith form, and combinations thereof.

26. The system of claim 25, wherein the particulate adsorbent comprises at least one member selected from the group consisting of irregular granular shapes, spherical shapes, cylindrical shapes, and combinations thereof.

27. The system of claim 25, wherein the monolith adsorbent comprises at least one form selected from the group consisting of extruded honeycomb with parallel cell passages, layered sheets with parallel passages, jelly-rolled sheets with parallel cell passages, bound aggregates of particulates with randomly distributed voidages for vapor flow, and combinations thereof.

28. The system of claim 18, wherein the heat input comprises at least one member selected from the group consisting of electrical resistance heaters, positive temperature coefficient ceramics, heat exchange, heat transfer fluid, and combinations thereof.

29. The system of claim 18, wherein the heat input comprises at least one member selected from the group consisting of heaters located external to the adsorbent volumes, heaters internal to the adsorbent volumes, electrically conductive adsorbent volumes with heat applied by electrical current flow, and combinations thereof.

30. The system of claim 29, wherein the heat input internal to the adsorbent volumes comprises at least one member selected from the group consisting of heaters in non-bonded contact with adsorbents, and heaters in bonded contact with the adsorbents.

31. The system of claim 29, wherein the electrically conductive adsorbent volume component comprises at least one conductive material selected from the group consisting of conductive adsorbents, conductive substrates, conductive additives, conductive binders, and combinations thereof

32. The system of claim 31, wherein the conductive component material is added at a step comprising at least one member selected from the group consisting of adsorbent preparation step, intermediate adsorbent shaping step, final adsorbent shaping step, and combinations thereof.

33. The system of claim 18, wherein the heat input along the purge outlet flow path has same intensity throughout the path or has different local intensities.

34. The system of claim 18, wherein the heat input comprises at least one member selected from the group consisting of heat applied after adsorption prior to purge flow and heat applied during purge flow.

35. A canister operative for use in automotive systems for emission control defined by a canister vapor inlet to permit a fuel vapor flow path through an initial volume of vapor adsorbent within a first region of the canister toward a canister vent/air opening to permit a continued air flow path through a subsequent volume of adsorbent within a second region of the canister at the vent/air opening and the first region at a canister purge outlet, such that fuel vapor formed in a tank for storing volatile fuel flows through the canister vapor inlet into the initial volume of adsorbent where it is adsorbed and, during operation of an engine induction system, ambient air is caused to flow in a path to and through the vent/air opening and along the air flow path in the canister through the initial volume and the purge outlet to the induction system of the engine, wherein the flow of air removing a portion of the adsorbed fuel vapor but leaving a residue of fuel in the initial volume, and wherein:
(i) the purge flow is subjected through unheated adsorbents along a portion of the purge inlet of the vapor flow path length of the adsorbents; and
(ii) the purge flow is subjected through heated element along the purge outlet of the vapor flow path length of the adsorbents, wherein the heated element comprises at least one member selected from the group consisting of heater located in the plenum, heated plenum, heated adsorbent, and combinations thereof.

36. The canister operative of claim 35, wherein the purge inlet comprises at least one member selected from the group consisting of a path length with the main vapor recovery canister and an auxiliary canister in-series in purge flow with the main vapor recovery canister.

37. The canister operative of claim 36, wherein the auxiliary canister includes at least one adsorbent selected from the group consisting of particulate form, monolith form, and combinations thereof.

38. The canister operative of claim 36, wherein the auxiliary canister includes ceramic-bound carbon honeycomb adsorbent.

39. The canister operative of claim 35, wherein the adsorbent comprises at least one member selected from the group consisting of zeolites, porous silicas, porous aluminas, pillared clays, molecular sieves, porous polymers, activated carbons, and combinations thereof.

40. The canister operative of claim 39, wherein precursor of the activated carbon comprises at least one material selected from the group consisting of wood, peat, coal, coconut, lignite, petroleum pitch, petroleum coke, coal tar pitch, fruit pits, nut shells, sawdust, wood flour, synthetic polymer, and natural polymer having been activated by a process selected from the group consisting of chemical, thermal, and combined chemical/thermal activation methods.

41. The canister operative of claim 35, wherein the adsorbent comprises at least one type of adsorbents.

42. The canister operative of claim 35, wherein the adsorbent comprise at least one member selected from the group consisting of particulate form, monolith form, and combinations thereof.

43. The canister operative of claim 42, wherein the particulate adsorbent comprises at least one member selected from the group consisting of irregular granular shapes, spherical shapes, cylindrical shapes, and combinations thereof.

44. The canister operative of claim 42, wherein the monolith adsorbent comprises at least one form selected from the group consisting of extruded honeycomb with parallel cell passages, layered sheets with parallel passages, jelly-rolled sheets with parallel cell passages, bound aggregates of particulates with randomly distributed voidages for vapor flow, and combinations thereof.

45. The canister operative of claim 35, wherein the heat input comprises at least one member selected from the group consisting of electrical resistance heaters, positive temperature coefficient ceramics, heat exchange, heat transfer fluid, and combinations thereof.

46. The canister operative of claim 35, wherein the heat input comprises at least one member selected from the group consisting of heaters located external to the adsorbent volumes, heaters internal to the adsorbent volumes, electrically conductive adsorbent volumes with heat applied by electrical current flow, and combinations thereof.

47. The canister operative of claim 46, wherein the heat input internal to the adsorbent volumes comprises at least one member selected from the group consisting of heaters in non-bonded contact with adsorbents, and heaters in bonded contact with the adsorbents.

48. The canister operative of claim 46, wherein the electrically conductive adsorbent volume component comprises at least one conductive material selected from the group consisting of conductive adsorbents, conductive substrates, conductive additives, conductive binders, and combinations thereof

49. The canister operative of claim 48, wherein the conductive component material is added at a step comprising at least one member selected from the group consisting of adsorbent preparation step, intermediate adsorbent shaping step, final adsorbent shaping step, and combinations thereof.

50. The canister operative of claim 35, wherein the heat input along the purge outlet flow path has same intensity throughout the path or has different local intensities.

51. The canister operative of claim 35, wherein the heat input comprises at least one member selected from the group consisting of heat applied after adsorption prior to purge flow and heat applied during purge flow.
